(19) United States
(12) Patent Application Publication
(10) Pub. No.: US 2019/0050775 A1
(43) Pub. Date: Feb. 14, 2019

(54) CONFIGURING AN APPLICATION FEATURE USING EVENT RECORDS

(71) Applicant: Uber Technologies, Inc., San Francisco, CA (US)

(72) Inventors: Rahul Bijor, San Francisco, CA (US); Miraj Rahematpura, San Francisco, CA (US)

(21) Appl. No.: 15/675,678

(22) Filed: Aug. 11, 2017

(51) Int. Cl. G06Q 10/06; H04L 29/08

(52) U.S. Cl. CPC G06Q 10/06316; H04L 67/18; G06Q 50/30; H04L 67/20; H04L 67/22

(57) ABSTRACT

A system is provided to access at least a first data source of a user, to identify an indicator of an upcoming event. The system determines a category for the event, as well as a set of service-related parameters for the event. The system may generate a workflow that is specific to at least one of the category or the set of service-related parameters, to determine a set of configuration parameters. In some examples, a request interface is provided, having a feature from which the user can generate a service request for the event. An aspect of the feature may be based at least in part on the set of configuration parameters. Additionally, in some examples, a set of service-related parameters may be associated with the feature, so that when the service request is generated, the generated service request dynamically incorporates information corresponding to the set of service-related parameters.

### TECHNICAL FIELD

Examples described herein relate to a system to configure an application feature using event records.

### BACKGROUND

Numerous on-demand services exist to offer users a variety of services: transportation, shipping, food delivery, groceries, pet sitting, mobilized task force and others. Typically, on-demand services leverage resources available through mobile devices, such as wireless (e.g., cellular telephony) devices, which offer developers a platform that can access sensors and other resources available through the mobile device. Many on-demand services include dedicated applications (sometimes referred to as “apps”) to communicate with a network service through which an on-demand service is offered.

### BRIEF DESCRIPTION OF THE DRAWINGS

FIG. 1A illustrates a system to configure a service application based on event information.

FIG. 1B is a block diagram representation of an application feature, according to one or more examples.

FIG. 2 illustrates an example method for configuring a service application based on event information.

FIG. 3A through FIG. 3E illustrate alternative examples of application interfaces for use with a service application.

FIG. 4 is a block diagram that illustrates a computer system upon which embodiments described herein may be implemented.

FIG. 5 is a block diagram that illustrates a mobile device upon which examples described herein may be implemented.

### DETAILED DESCRIPTION

According to some examples, a system is provided to configure an application interface based on events that are detected from a user data source (e.g., calendar data on user device, online calendar, social network feed, etc.).

According to some examples, a system analyzes event information from one or more user data sources in order to detect events that relate to the user. For each detected event, the system determines a category to associate with the event. Additionally, the system may determine a set of service-related parameters for the event. The system may configure an application interface for a service application operating on a user device, where a service (e.g., transport service) related to the event may be requested.

In some examples, the system determines the set of configurations by implementing a workflow that is specific to at least one of the category or the set of service-related parameters. In some examples, a request interface is provided, having a feature from which the user can generate a service request for the event. An aspect of the feature may be based at least in part on the set of configuration parameters. Additionally, in some examples, a set of service-related parameters may be associated with the feature so that when the service request is generated, the generated service request automatically includes information corresponding to the set of service-related parameters.

Examples recognize that in the technical field of on-demand services, users place a heavy reliance on their mobile devices. Mobile devices are increasingly used in connection with numerous services which users employ more frequently. Many on-demand services use service applications, or “apps” which the user can launch to receive services. For example, users can request food delivery, package delivery, transportation services (e.g., ride sharing) and other services using apps that run on their mobile devices. In these and other scenarios, the mobile devices of the users can be taxed of battery, particularly when the user's devices are actively engaged with an on-demand service. Moreover, the amount of interaction the user may have with a service application may be distracting to the user, particularly since the mobile devices are used for so many different purposes (e.g., messaging, browsing, using other on-demand services).

In this context, examples enable an interface or feature of an application (e.g., service application) to be configured in connection with an event in a user's schedule. In at least some examples, an application interface or feature may be provided with text or image content that is dynamic and informative, in a way that is meaningful to the user. By way of example, an application feature may be configured to enable a user to trigger performance of a default action, or set of actions, in order to facilitate the user with an event that is detected on the user's schedule. In the context of on-demand ride sharing, a service request interface of a service application can include one or multiple selectable features from which the user may make selection. Once the feature is selected, the service application may generate a service request that automatically includes a destination. For such applications, examples enable the request interface of the application to provide selectable features (e.g., “accelerators”), having image and/or text content that serves an objective of personalization, information, and/or business logic. By way of example, the application features may be iconic, selectable triggers that include image and/or text to (i) communicate information about an upcoming event (e.g., image of featured person of event, image of source of event); (ii) communicate information about a default action that will take place to have the person arrive at the event; and/or (iii) provide dynamic information that may relate to how or when the service application makes a service request.

Among other benefits, by configuring such application features, examples enable the user to reduce direct inputs to the mobile device, thereby conserving power and resources of the user's mobile device. Moreover, the application interface can be provided to reduce the amount of time that would otherwise be needed for the user to make a service request.

As used herein, a client device refers to devices corresponding to desktop computers, cellular devices or smartphones, wearable devices, laptop computers, tablet devices, television (IP Television), etc., that can provide network connectivity and processing resources for communicating with the system over a network. A driver device can also correspond to custom hardware, in-vehicle devices, or on-board computers, etc. The client device and/or the driver device can also operate a designated application configured to communicate with the service arrangement system.

While some examples described herein relate to transport services, the service arrangement system can enable other on-demand location-based services (e.g., a food truck service, a delivery service, an entertainment service) to be arranged between individuals and service providers. For example, a user can request an on-demand service, such as a delivery service (e.g., food delivery, messenger service, food truck service, or product shipping) or an entertainment service (e.g., mariachi band, string quartet) using the system, and the system can select a service provider, such as a driver, food provider, band, etc., to provide the on-demand service for the user.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

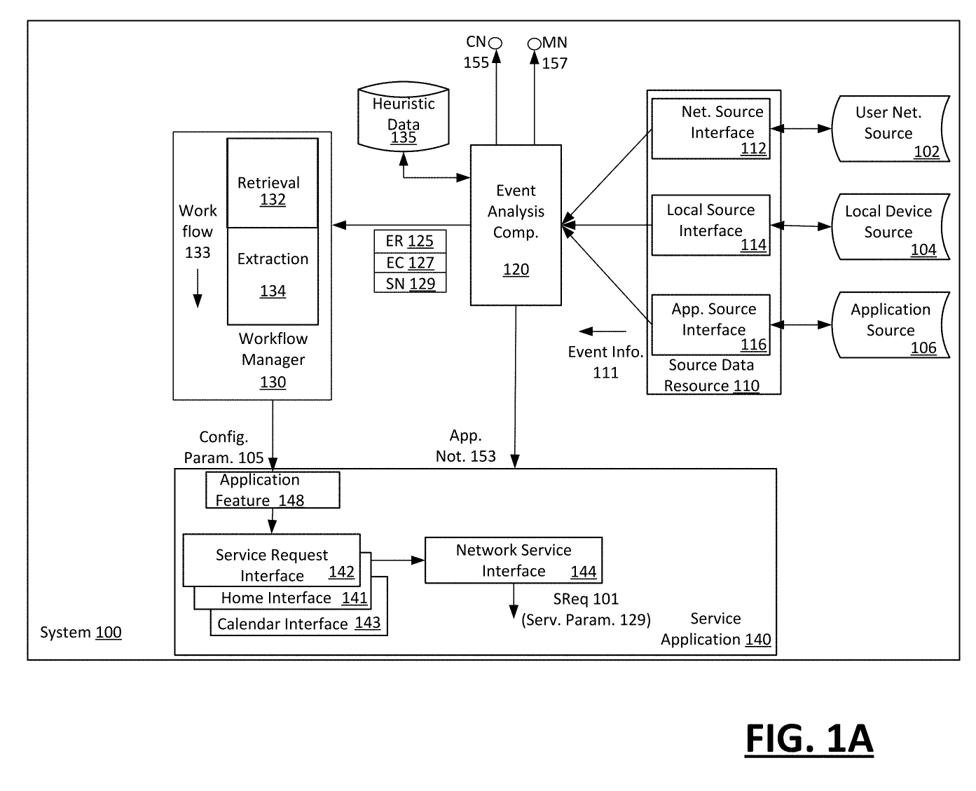

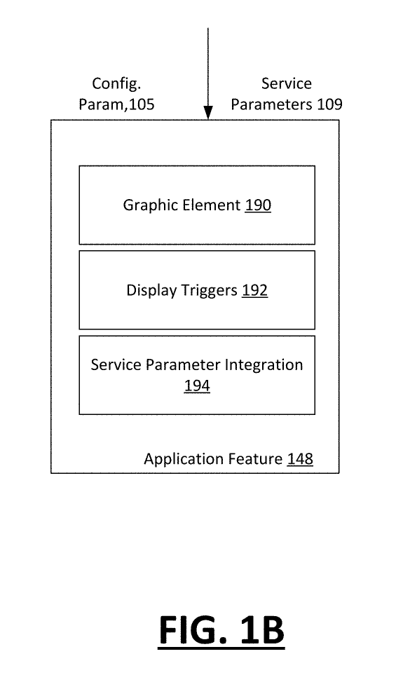

FIG. 1A illustrates a system to configure a service application based on event information. In particular, a system 100 may be implemented to augment a service application 140 that executes on a mobile computing device of a user. According to some examples, the service application 140 enables the user to access and use an on-demand service, such as an on-demand transportation service. By way of example, the service application 140 can be operated on a given user's mobile device to generate and receive requests for transport. The system 100 may be implemented to configure aspects of the service application 140 (e.g., application features 148, as described below) to specific requisites and/or preferences of the user. More specifically, the system 100 may be implemented to analyze event records of the user from various sources, in order to customize the appearance and operation of application features 148 for use with an on-demand service. As described in greater detail, the system 100 may include a source data resource 110, an event analysis component (“EAC 120”) and a workflow manager 130 that operate to determine a set of configuration parameters 105 for application features 148 of the service application 140.

In some examples, the system 100 includes programmatic components that execute on the mobile device of the user in order to implement functionality as described. In some variations, the components of system 100 may be implemented as part of the service application 140, or alternatively, separate from the service application 140 (e.g., as a separate application, program or plug-in).

In other variations, one or more components of the system 100 may be implemented as part of a network service that communicate with the service application 140 to configure the application features 148. For example, the system 100 can be implemented as part of an on-demand transportation service, in order to tailor application features of service application 140 for specific events and preferences of individual users. The system 100 may also be implemented as a distributed architecture, such as one in which components of the system 100 are provided on a server, or combinations of network computers. In such variations, the components of the system 100 utilize one or more computer networks in order to communicate with the service application 140, or with other components that implement functionality of system 100. For example, some components of the service application 140 (e.g., such as the workflow manager 130, described below) which may be executed on a server or as part of a network service, while another component (e.g., EAC 120) may be implemented locally on the device, as part of the service application 140 or as a separate component.

As described, examples enable the service application 140 to incorporate application features 148 that minimize user interaction and use of the user's computing device (e.g., thereby reducing power consumption of the user's power supply), while adding to the convenience of the user. At the same time, the system 100 can configure application features 148 of the service application 140 to provide information and functionality which the end user may not even know to ask for, with an objective to meet the user's request (e.g., arrive at a destination at a given time) in an efficient and reliable manner.

In an example, the source data resources 110 includes one or more interfaces (e.g., application programming interfaces, connectors, etc.), to enable access and/or retrieval of event information 111 from corresponding data sources of the user. The event information 111 may include records or other data items that indicate a future event of relevance to the user. In some examples, the source data resources 110 includes network source interface 112 and/or local source interface 114. The network source interface 112 implements one or more processes that operate to obtain event information 111 for the user from a user's network source 102 (e.g., social network account, online calendar, etc.). The local source interface 114 implements one or more processes to obtain event information from a local device source 104 (e.g., Sim card, OS calendar or feature of mobile device, etc.). Still further, the application source interface 116 may be used to obtain event information 111 from a third-party application resource 106 (e.g., calendaring application, trip planner, messaging application, reservation service application, etc.), including an application library or data set of application running on the mobile device of the user.

The EAC 120 analyzes event information 111 in order to identify upcoming events. The EAC 120 may identify events of varying likelihood, such as probable events, or less likely events. Thus, the analysis performed by the EAC 120 may take into account a confidence score, reflecting whether, for example, event information 111 detected from one of the data sources 102, 104, 106 associated with the user, is actually relevant to the user. The determination of relevancy may include a determination of whether such event information 111 is indicative of an upcoming event of a pre-defined event type. By way of example, the event information 111 can include calendar event records, social media feeds, and tokenized data text retrieved from records, documents or files. Accordingly, the event information 111 can include content (e.g., text embodied in a calendar event), metadata (e.g., a name of a calendar event record or contact record) and attributes (e.g., an identification of the source of a record, creation date, identifier of the person who created the record, etc.).

Accordingly, in some examples, the EAC 120 performs the analysis of the event information 111 to (i) detect potential events from the event information 111 retrieved from the user's data sources 102, 104, 106; and (ii) determine a confidence score for each detected event, where the confidence score reflects a likelihood that a user-relevant event is reflected by corresponding event information 111. Additionally, the EAC 120 implements an analysis process to determine a category of an event that is deemed relevant to the user. For example, the EAC 120 may identify the category of the event as being one of a predefined set of event categories, such as a calendar event (e.g., holiday), a celebration, a travel related event (e.g., air travel, vacation, commuter event), a reservation (e.g., dinner reservations at a restaurant), a professional appointment (e.g., doctor appointment) or a social gathering (e.g., meet at friend's house).

In some variations, the EAC 120 may also analyze the event information 111 to determine a set of service parameters 129 that can be used with a service request, when one is generated by the service application 140 in connection with the identified event. The service parameters 129 may, for example, identify a service location that is to be included with a corresponding service request 101. For example, the EAC 120 may automatically determine the set of service parameters for a transport service request to match that of the location of an upcoming event. Similarly, the EAC 120 may automatically determine a time for when a service request is to be made based on a start time of an event.

According to some examples, the EAC 120 utilizes heuristic data 135 to (i) detect events from event information 111, (ii) determine the respective confidence scores of detected events, (iii) determine category designations for detected events, and/or (iv) obtain additional information about the detected events (such as relevant service parameters). The heuristic data 135 may include, for example, a library of rules that associate keywords and terms used as content in the event information 111 (e.g., the content of a retrieved event record) with determinations of event detection, event identification, event category, and/or service parameters. The heuristic data 135 may also associate metadata and/or attributes of event information 111 with such determinations. The heuristic data 135 may also correlate a relative strength of the associations identified by the individual rules (or rule sets), to provide a determination of a confidence score.

By way of example, the heuristic data 135 may employ association rules that determinatively link content, metadata and/or attributes of a given event record with a corresponding determination (e.g., a calendar record created by a user in a birthday calendar is a birthday event that is relevant to the user). Additionally, the heuristic data 135 may include association rules that weight a given determination between event content, metadata and/or attributes to the event detection. For example, a calendar record that is created by another user may be weighted as an event indicator based on the content of the record (e.g., text of the calendar record includes “party” or “celebration”), but the activity associated with the creator of the record (someone other than the user) may result in a non-determinative determination (e.g., a determination where the event is of possible interest to the user). In the same example, if the attributes or related data associated with the calendar event record indicates the record originated as an invitation that was accepted by the user, then the association may be determinative, and the event may be deemed as being interest to the user.

In additional examples, the heuristic data 135 may include association rules that link a content, metadata, attribute or associated data of a detected event with a corresponding category. For example, the heuristic data 135 may include rules that link keywords in the content of a calendar event record with a category type selected from a predetermined set of event categories. For example, an event category may correspond to one of a calendar event, celebration, travel-related event, air travel, vacation, commuter event, reservation, professional appointment or social gathering. The heuristic data 135 may also provide a confidence score with the category determination, based on a strength of the correlation between the keywords and terms and the event categories.

In some examples, the EAC 120 verifies one or more of the determinations made from the event information 111. The EAC 120 may, for example, generate a notification (e.g., provided to user through the service application 140) to verify a detected event and/or information determined about the detected event (e.g., event category, service parameters, etc.). For example, the EAC 120 may trigger the service application 140 to generate a notification such as “Are you planning to go to John's wedding on July 15?” For such examples, the EAC 120 may record the event information 111 when verification input is received. In some cases, such as when the association of the EAC 120 is deemed determinative, the EAC 120 may omit separate verification and record the event.

In some examples, the EAC 120 may populate an electronic calendar for use with the service application 140. For example, the EAC 120 may populate a calendar interface 143 of the service application 140, or a designated user calendar provided by a separate application or service. The EAC 120 may generate calendar events which the user can accept, reject, or take no action. The user action (e.g., acceptance, no action) may provide verification of the determinations of the EAC 120.

According to some examples, the EAC 120 utilizes heuristic data 135, gathered from an aggregation of users in a given population. By way of example, the workflow manager 130 may obtain heuristic data 135 for an event based on the category and location of the event. As another example, the heuristic data 135 may relate to a frequency by which other users cancel service requests that were automatically generated for the particular category of events. The heuristic data 135 may also consider the location and time of the event. Thus, for example, a social calendar event on a Friday evening may justify, through the analysis of heuristic data 135, an automatic trigger or condition by which the service application 140 is to automatically generate a transport service request to have the user arrive at the location of the event on time. In such cases, the EAC 120 may provide the application feature 148 with configurations that include an automated trigger tied to, for example, a time period when the action is to be performed. Based on analysis of heuristic data 135, the same type of social calendar event on another evening may cause the EAC 120 to provide the application feature 148 as a shortcut action which the user must trigger in order for the service request to be sent. In the latter example, the application feature 148 may be provided in the form of an icon, notification and/or alert, through execution of the service application 140, based on a probability or likelihood (as determined from the heuristic data 135) that the user will attend the event.

For example, the EAC 120 may process verifications received from individual users in a given group, and then adjust the rules and/or their respective correlations (or weights) of the heuristic data 135 based on the verification inputs of the population of users. Additionally, the EAC 120 may select what type of verification is to be sought from the user based on, for example, the event type, the confidence score associated with the event determinations, and/or service parameters, attributes or other data of the determined event. In this manner, the EAC 120 may generate one or more types of verifications, such as an application notification 153, calendar (or third-party) notification 155, and/or messaging notification 157, for different events. The application notification 153 may, for example, be generated for event types that are deemed to require verification (e.g., less confidence score) and/or more urgent or important events (e.g., for air travel event). Depending on implementation, the application notification 153 may be generated on the home interface 141, service request interface 142, and/or calendar interface 143. The EAC 120 may specify the verification to be using the third-party notification 155 for other events. Still further, the EAC 120 may use messaging notification for less important events, or events which are further out in time. In response to receiving one of the notifications 153, 155, or 157, a user may respond with input (i) to confirm or reject an interpretation of the event information 111 as a detected event, or a type of event; (ii) to confirm or reject that the detected event is of interest to the user. The EAC 120 may record the user's input as part of, for example, heuristic data 135 to improve, for example, the accuracy of the determinations made by the EAC 120.

In an example, the EAC 120 generates an event record 125 to reflect the determinations of a detected event, as well as detected information such as event category 127 and/or detected service parameters 129. The event record 125 may be stored on a device or user data store for subsequent use. For example, the event record may be displayed as a calendar feature on a user interface of the service application 140. In another example, the event record 125 may be displayed as a snippet of content on a home panel that is rendered with launch of the service application 140, or as part of a request screen.

The EAC 120 may utilize the workflow manager 130 to implement an application feature 148, having a configuration that is specific to a determination of the EAC 120 with respect to the corresponding event record 125. The application feature 148 may be implemented as part of, for example, the home interface 141, the service request interface 142, and/or the calendar interface 143. In some examples, the application feature 148 corresponds to a shortcut that triggers a service request from a network service interface component 144 of the service application 140. The application feature 148 may be triggered by user input. Once the application feature 148 is triggered, the service application 140 may automate the inclusion of service parameters 129 with the generated service request, based on, for example, the contents of the event record 125 provided from the EAC 120. Thus, for example, the EAC 120 may process event information 111 of a user to detect a celebration event, then detect the location of the celebration event as the service parameter. The event record 125 may record an event descriptor (e.g., “Birthday for Tom”), street address of the event, and time when event starts. The application feature 148 may be generated to enable the user to perform a shortcut action (e.g., screen tap on an icon corresponding to the application feature 148) at an appropriate time to generate a transport service request. The network service interface component 144 may generate the transport service request to automatically include service parameters, with the destination being identified from the event record 125 (corresponding to the street address).

In some examples, the EAC 120 implements a set of configuration parameters 105 for the application feature 148, based on the determinations of the EAC 120 with respect to event detection, type, service parameters or other related information. Among other variations, the EAC 120 may configure the application feature 148 of a particular event to be active for a selected duration that is relevant to the corresponding event. The duration in which the application feature 148 is configured to be active may be specific to information contained in the event record, such as the type of event and/or the estimated travel time to the event.

As an addition or variation, the set of configuration parameters 105 affect the appearance of a trigger for the application feature 148. For example, the set of configuration parameters 105 may display the trigger for the application feature 148 in the form of an icon or calendar entry. Additionally, the set of configuration parameters may provide for the appearance of the application feature 148 to include content (e.g., image, text) that is selected based at least in part on the category or service parameter associated with the corresponding detected event. In such examples, the content of the icon (or other trigger) for the application feature 148 may reflect, for example, an indication of the event category or the service parameter of the event.

As an addition or variation, the EAC 120 may specify one or more configuration parameters 105 to affect a functionality associated with the application feature 148. The configuration parameters 105 may specify, for example, whether the application feature 148 is to be provided as an alert, a calendar event, a user selectable trigger, and/or an automated trigger. The set of configuration parameters 105 may also specify whether the application feature 148 is to be provided with a particular panel or interface of the service application 140, such as with the home interface 141, the service request interface 142, or the calendar interface 143. In one implementation, the application feature 148 is generated as a user-triggerable shortcut action. Once triggered, the service application 140 may execute to automate inclusion of service request parameters 129 with a generated service request 101, transmitted from a network service interface component 144. In this way, the service application 140 generates a transport service request that automatically identifies a service location such as the destination. In some implementations, the set of configuration parameters 105 provide an automated trigger for the application feature 148. As an automatic trigger, the service application 140 may automatically generate the transport service request, and further specify the location of the event as a destination parameter of the transport service request. In such an example, the application feature 148 may automatically trigger unless some intervening action is taken by the user to delay or cancel the event. Still further, in some variations, the application feature 148 may be implemented as an extension feature or plug-in for another third-party application (e.g., calendar application). The selection of the application feature 148 from the other application can automate a sequence of actions, such as for example, opening the service application 140, and generating (with or without sending) a service request that automatically includes one or more service parameters determined from the event record 125.

In some examples, the EAC 120 utilizes the workflow manager 130 in order to determine at least some of the configuration parameters 105 for the application feature 148. The workflow manager 130 may implement a multistep process, or workflow 133, in order to determine configuration parameters 105 to (i) affect an appearance of the feature application feature 148, and (ii) identify programmatic triggers and operations that are to be performed with respect to the use of the application feature 148. According to some examples, the workflow manager 130 may select, create or otherwise implement a specific workflow 133 based on a category designation associated with a given event record 125. By way of example, the selected workflow 133 may utilize a retrieval component 132 to access an information source over a computer network, where the information source is selected based on the event category 127, service parameters 129 and/or other information of event record 125. The retrieval component 132 may also acquire information from information sources which are selected or identified by, for example, a user profile or account (e.g., preference of user, past activities of the user, etc.). In this manner, the retrieval component 132 may acquire supplemental information that is specific to an event, an event category, and/or a user. In some examples, the workflow manager 130 may sequence the operations of the retrieval component 132, in order to acquire a specific type of supplemental information that is related to a determined event.

The extraction logic 134 may extract information from the supplemental information for use in configuring the application feature 148. For example, the extraction logic 134 may extract an image element from the supplemental information. The extracted information may be provided as one of the configuration parameters 105, to configure as, for example, a visual trigger for the application feature 148.

In some examples, the implemented workflow 133 can be heuristically determined, either before or after the workflow is initiated. For example, the EAC 120 may analyze the event record 125 to categorize the event as an airplane trip event. The workflow manager 130 may construct and implement the workflow 133 to determine configuration parameters corresponding to, for example, content elements, links, or triggers. The workflow manager 130 may utilize the heuristic data 135, as well as the determinations of the EAC 120, in order to perform specific processes of the workflow 133. The processes of the workflow 133 may include, for example, retrieval 132 and/or extraction 134. The retrieval 132 includes a programmatic process to retrieve information and content from network locations and remote data sources where relevant information can be found for the event record 125. The retrieved information may include information items other than what may be contained in the event record 125 itself. As described with various examples, the retrieval 132 can be targeted to data sources such as, (i) user's data store, such as for pictures, links and/or credentials to a user's online accounts (e.g., social network account, online calendar, etc.); and/or (ii) commercial data stores, such as provided for online reservations of airlines, hotels, restaurants, etc. The extraction 134 can parse and tokenize the retrieved information, to identify elements of the retrieved information that can be suitable for use as content, a link or trigger (e.g., geographic coordinate, day and time, etc.).

The workflow manager 130 can package the tokens (e.g., content element, link, trigger) of the extraction 134 as a set of configuration parameters 105 for the application feature 148. The workflow manager 130 may repeat retrieval and extraction processes 132, 134 in order to determine the configuration parameters 105 for a given application feature 148. For example, a first instance of the workflow 133 can be used to retrieve an airline and/or flight number from a reservation database. The workflow 133 may implement a second retrieval process to identify a business logo associated with the airline. Additionally, the configuration parameters 129 may be used to configure the application feature 148. In this way, the application feature 148 can be configured in appearance, associated or linked to service parameters 129, and other functionality.

Still further, in some examples, separate instances of the workflow 133 may be used to determine when, for example, the application feature 148 is to be triggered. When triggered, for example, the application feature 148 becomes visible or otherwise available on a user interface of the service application 140 (e.g., the application feature 148 becomes visible on a portion of the request interface 142). By way of example, the trigger for the application feature 148 may correspond to a time, a day, a current geographic location, or another type of contextual information.

In some examples, the workflow manager 130 may implement a separate workflow 133 in order to determine a trigger for when the application feature 148 becomes available. For example, the event record 125 may identify an air trip to a destination. The workflow manager 130 may implement a workflow 133 to retrieve, for example, real-time flight information from a flight database. The extraction component 134 may parse the reservation time information, so that tokens, corresponding to, for example, the departure city, terminal and the time of departure, are retrieved from the event record 125. The trigger for the application feature 148 may be based on the time needed for the user to arrive at the airport (e.g., two hours in advance), given the determined information (e.g., departure city and time, airline, terminal, etc.). Accordingly, the workflow 133 may also implement the retrieval component 132 to retrieve a route or time of travel from a mapping or navigation service, using a current location of the user. In some aspects, the trigger may be dynamic, so as to change based on, for example, a location of the user. Thus, the time when a given application feature is shown by the service application 140 may vary based on the current location of the user.

FIG. 1B is a block diagram representation of an application feature, according to one or more examples. According to some examples, the service application 140 may provide a set of one or multiple application features 148 on a given interface when the application is executed on the mobile device. Each of the application features 148 may be selectable to trigger the mobile device (or service application 140) to perform operations that result in the generation of a service request 101.

According to some examples, the application feature 148 may include a graphic element 190, one or more display triggers 194 and a service parameter integration 194. The configuration parameters 105 can include image data, such as an iconic image or a dynamic set of images, corresponding to a selection of content element by the workflow manager 130. In variations, the configuration parameters 105 may specify a link from which the graphic element 190 can be retrieved. In such examples, the graphic element 190 may include functionality for retrieving content from a network location identified by the link. The graphic element 190 includes personalized content (e.g., images from an image store of the user), business logic content (e.g., business logos), as well as textual content that can be updated repeatedly or continuously to provide information to the user. In an example in which an event record 125 specifies an airline flight, the graphic element 190 may repeatedly retrieve and display flight status information for the user, so that the application feature 148 displays text content corresponding to the status of the user's flight (e.g., on time, delayed, etc.). As another example, graphic element 190 may include text content, or alternatively symbolic or iconic content, corresponding to an indication when transport service should be requested to enable the user to arrive at a particular location or event on time (e.g., time for when user should depart for airport). The application feature 148 may be implemented as an iconic user-interface feature that is selectable to cause the service application 140 to transmit the service request 101.

According to some examples, one or more display triggers 192 can implement configurable rules or functionality which control when a given application feature 148 is displayed on an application interface of the application 140. In variations, one or more display triggers 192 may determine when individual application features 145 are available for use by a user of the mobile device (e.g., such as when the features are inactive and hidden). In some implementations, a display trigger 192 can be configurable by one or more configuration parameters 105, relating to detected or determined event records of the user. In one implementation, the display trigger 192 can determine a time before a given event of a given event record when the application feature 148 is to be displayed or made available. In variations, the display trigger 192 can be based on the current location of the user. The selection of whether a given display trigger 192 can account for timing or location may be specified by the configuration parameters 105.

As an addition or variation, the application feature 148 can include service parameter integration 194. As described with an example of FIG. 1A, the EAC 120 may analyze event information 111 of the user in order to determine service parameters 129, such as a destination for a user's transport service request. As another example, the service parameters 129 may specify type of service, a time when the service to be initiated, a time when service should be completed, an expected price for the service, or various other types of information.

As described with examples of FIG. 1B, the appearance of the application feature 148 may be dynamic, so as to change with time, position or in response to certain events. Likewise, functionality associated with the application feature 148 may vary based on factors such as time and position of the user.

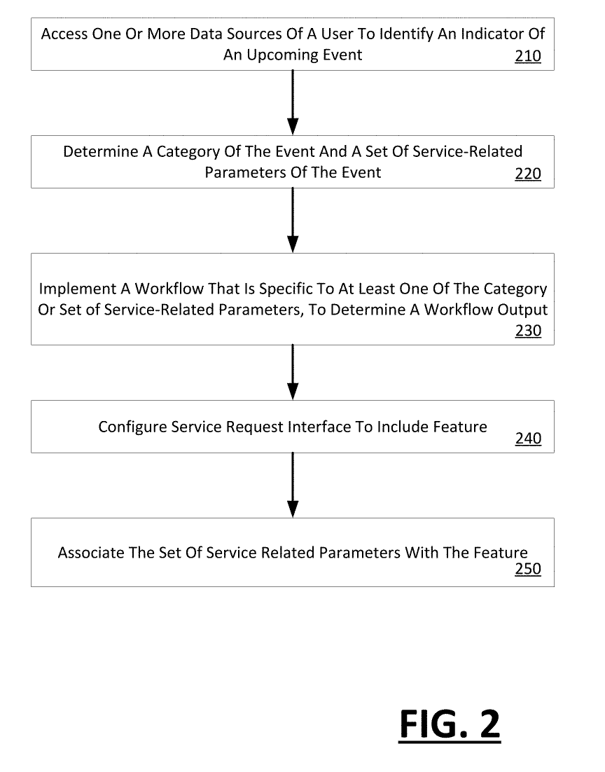

FIG. 2 illustrates an example method for configuring a service application based on event information. A method such as described with an example of FIG. 2 may be implemented using, for example, a system such as described with an example of FIG. 1A or FIG. 1B. Accordingly, reference may be made to elements of FIG. 1A and FIG. 1B for purpose of illustrating suitable components and functionality for performing a step or sub-step being described.

With reference to FIG. 2, one or more programmatic processes may be used to interface and extract event information from one or more source data resources 110 of a user (210). By way of example, the event information may be retrieved from a user's local device calendar, a user's online calendar, a social network site, calendar or feed, for the user the user, and/or other local applications on a user's device.

The event information may be analyzed to detect individual events, and to determine a category for detected events (220). By way of example, the types of events which may be detected and categorized include a calendar event (e.g., holiday), a celebration, a travel-related event (e.g., air travel, vacation, commuter event), a reservation (e.g., dinner reservations at a restaurant), a professional appointment (e.g., doctor appointment) or a social gathering (e.g., meet at friend's house). In some examples, the detection of the event may be filtered and/or weighted to identify those events which the user may require a type of service made available through the service application 140. For example, in the context of the service application 140 being used to request transportation services, the EAC 120 may detect events which (i) are pertinent to the user, and (ii) are likely to require transportation for the user.

The system 100 may implement one or more workflows that are specific to a category or a set of service-related parameters. The workflow output may correspond to, for example, a notification that is communicated to the application 140, or to the respective mobile device. In some variations, the workflow output includes a set of configuration parameters 105 for configuring an application feature of an application (230). According to some examples, the set of configuration parameters may be specific to at least one of the category or set of service-related parameters. By way of example, the set of configuration parameters 105 may include image or text content.

According to some examples, the system 100 may use the set of configuration parameters to configure a service request interface to include an application feature from which the user can generate a service request for the detected event (240). In some examples, one or more of the determined configuration parameters 105 may affect an appearance of the application feature 145. For example, the application feature 145 may include a static or dynamic image, or descriptive text content. The application feature 145 may also be dynamic, in that an image or text of the application feature 145 may be changed over time. In the case of text content, for example, the text content may be changed to reflect, for example, updates to status information. In variations, the set of configuration parameters may affect, for example, a trigger that determines when the application feature 145 is provided to the user.

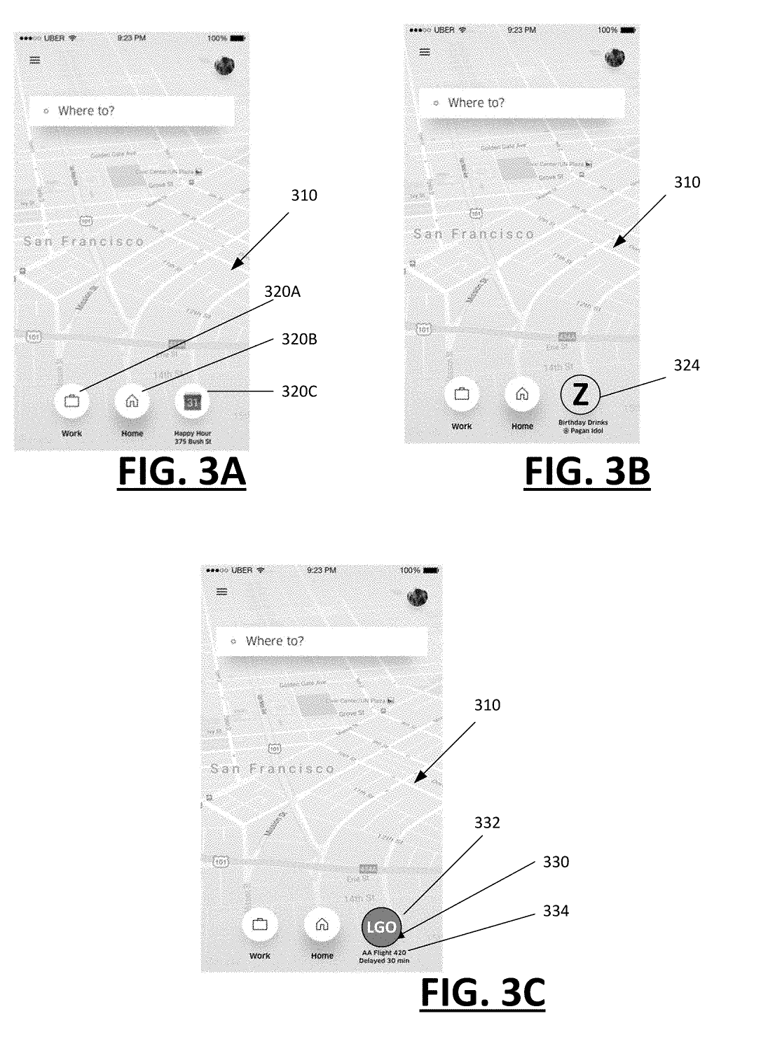

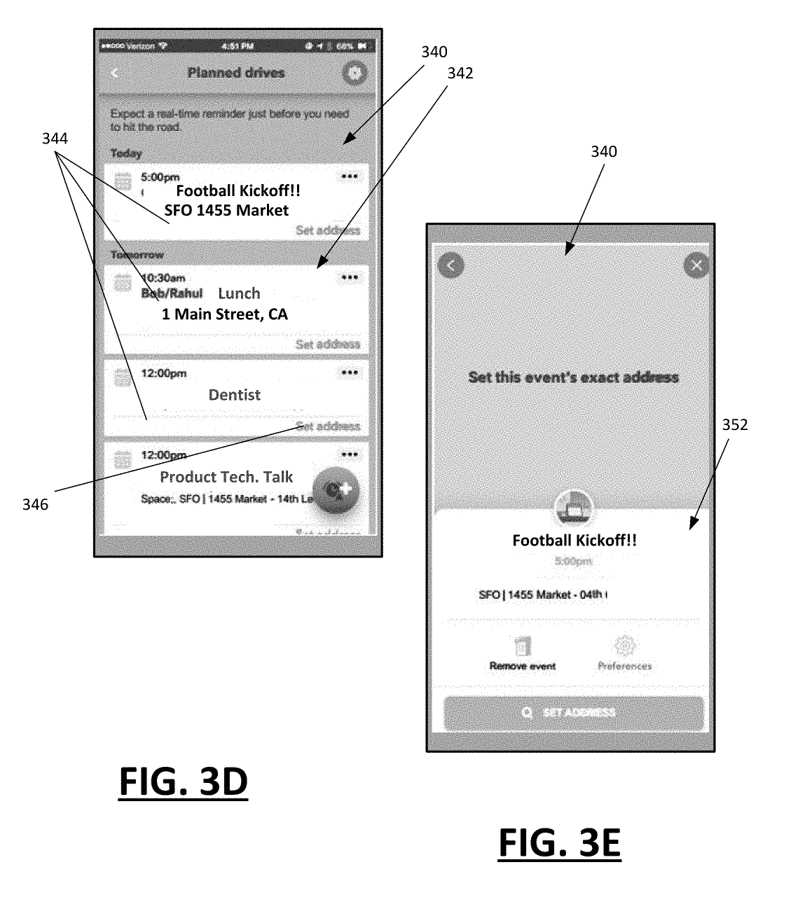

In some examples, a set of service-related parameters may also be associated with the application feature 148 (250). In such examples, the application feature 148 enables a service request to be generated that automatically includes one or more service-related parameters. For example, as described with FIG. 3A through FIG. 3E, a user may interact with the application feature 148 in order to make a transport service request in which the current location and destination are automatically included with the request.

FIG. 3A through FIG. 3E illustrate alternative examples of application interfaces for use with a service application. In particular, FIG. 3A through FIG. 3C illustrate examples of a request interface, such as provided by service application 140 (e.g., service request interface 142) with examples of FIG. 1A. FIG. 3D and FIG. 3E illustrate alternative calendar views of a calendar interface, such as provided by service application 140 (e.g., calendar interface 143) with examples of FIG. 1A. Accordingly, examples such as described with FIG. 3A through FIG. 3E may be implemented using, for example, a system such as described with examples of FIG. 1A and FIG. 1B. Examples of FIG. 3A through FIG. 3E may also be implemented using, for example, a method such as described with FIG. 2.

With reference to an example of FIG. 3A, an application interface 310 may be in the form of a service request interface. The application interface 310 may include multiple application features 320, each of which are selectable to cause the corresponding mobile device to generate and transmit a service request to a corresponding network service, where the service request can be handled. Each of the multiple application features 320 may be associated with a different set of service related parameters. For example, a first application feature 320A may be associated with a user's work, and a second application feature 320B may be associated with a user's home. In the example provided, a third application feature 320C (e.g., as provided by a configuration parameter 105) includes content that is based on event information determined from a user data source (e.g., such as a local or online calendar). The content of the application feature 320C may also include text content, identifying, for example, an address or other information that may be determined from the event record (e.g., information stored in the calendar record). In variations, the content of the application feature 320C may include information that is determined from implementation of a workflow. For example, the content of the application feature 320C may include a window of time for the event (e.g., “Happy Hour until 7 PM”). To obtain such information, the workflow manager 130 may identify, from the event record, the relevant location of the event (e.g., name of business where event is hosted), then employ the retrieval 132 to access the business' website. From the website, the retrieval 132 may obtain information related to hours when “Happy Hour” takes place. This information may then be displayed as part of the application feature 320C.

FIG. 3B illustrates an alternative example in which an event is associated with a source of the event record. As shown, one of the application features displayed on an interface of the application may include an image (e.g., logo 324) element that identifies a source of the event record. For example, one of the source data resources 110 may correspond to a user's social network account, where an event may be announced by the user, by friends of the user, or by persons followed by the user. The logo or other images may indicate to the user that the event is an online social network event. With selection of the feature, a service request may be initiated to a destination where the event it to take place. In variations, the workflow manager 130 may implement a workflow to identify other persons who may attend the event, and to use the retrieval component 132 to access images of persons who the user may be interested in seeing. Thus, in such an example, the image of the logo may be replaced by an image of a person who may attend the event.

FIG. 3C illustrates another example in which an application feature 330 is configured to include image 332 and text content 334. The image content 332 may be determined from, for example, the application of business rules and/or a workflow where a detected airline reservation is used to retrieve a logo of the airline. In some examples, the text content 334 may reflect information retrieved from a third-party source, such as an online airline reservation service. The text content may reflect status information, and may also be dynamic, so that change in flight status (e.g., flight delayed) may be reflected by the wording of the text content. According to some examples, the user may select the application feature 330 to request, for example, a transport service to a destination related to the event (e.g., airport).

With reference to an example of FIG. 3D, a calendar interface 340 is illustrated in a calendar list view 342 in which calendar records for successive events are displayed at once. Thus, the calendar list view 342 may coincide with the service application 140 being operated to display event records 344 of upcoming events in succession. Each event record 344 of the calendar list view 342 may also contain event information, such as the time and location of a corresponding event.

According to some examples, each event record 344 that is displayed in the calendar list view 342 may be selectable to enable the user to (i) make a service request to receive transport to the location associated with the corresponding event of the event record 344, and/or (ii) edit a service request to specify an address or location, service type, or other service related information (e.g., number of passengers and pickups).

In some variations, each record may include one or more interactive features, such as an address feature 346 to enable the user to specify a destination address for a service request that is to be associated with the corresponding event record 344. In this way, the user may interact with the service application by, for example, selecting a given event record 344, and the act of selection may cause a service request to be generated for the user. As described with other examples, the service record generated from the user interaction with the event record 344 may include service parameters (e.g., event location, service type) that are determined from information specified in the event record.

The user may also interact with individual event records 344 to specify or edit information contained in the event record. For example, the user may interact with the address feature 346 or other feature to edit information such as the event address, the event start time, or names of other attendees to the event.

In an example of FIG. 3E, the calendar interface 340 is illustrated in a record view 352. In variations, the calendar interface 340 may be provided views for alternative calendar durations, such as daily views, multi-day views, weekly view or monthly views. In the record view 352, the user can specify the address for the event, which may then be linked as a service parameter for a corresponding request that can be generated from user interaction with the record.

While examples of FIG. 3D and FIG. 3E include the calendar interface 340 as being a part of the service application 140, in variations, the service application (e.g., via the calendar interface 340) can create (or write to) a calendar record for a third-party calendar application or service. The information provided with the calendar record of the third-party calendar application or service may identify, for example, detected events for the user, as well as information about a planned service request for the event. With respect to examples described, variations may also provide for the service application 140 (e.g., via the calendar interface 340) to provide dynamic service-related information with individual calendar records. For example, a user may share an event record of the calendar interface with a group of contacts. The calendar interface may display dynamic map content that includes, for example, other users of the group (e.g., such as those individuals identified in the event record 344) arriving at the location of the corresponding event for the event record.

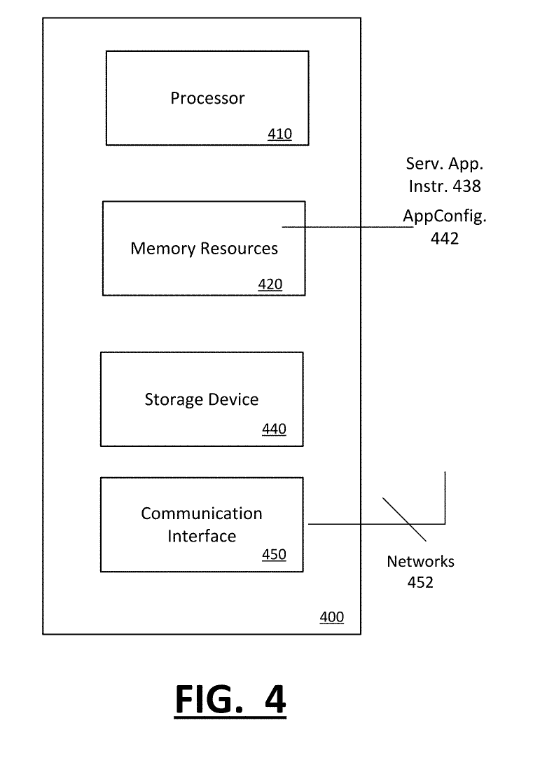

FIG. 4 is a block diagram that illustrates a computer system upon which embodiments described herein may be implemented. A computer system 400 can be implemented on, for example, a server or combination of servers. For example, the computer system 400 may be implemented as part of a network service for providing transport services. In the context of FIG. 1A and FIG. 1B, some or all of the functionality described with system 100 may be implemented using computer system 400. Likewise, a method such as described with an example of FIG. 2 may also be implemented

In one implementation, the computer system 400 includes processing resources 410, memory resources 420 (e.g., read-only memory (ROM) or random access memory (RAM)), a storage device 440, and a communication interface 450. The computer system 400 includes at least one processor 410 to process information (including storing temporary variables) and execute instructions stored in the memory resources 420. The computer system 400 may also include additional storage devices for storing static information and instructions for the processor 410. A storage device 440, such as a magnetic disk or optical disk, is shown for storing information and instructions.

The communication interface 450 enables the computer system 400 to communicate with one or more networks 452 (e.g., cellular network) through use of the network link (wireless or a wire). Using the network link, the computer system 400 can communicate with one or more computing devices, and one or more servers. In accordance with examples, the computer system 400 may establish individual communication channels over the one or more networks 452 with individual mobile devices of users, using for example, service applications that are operated on the respective mobile devices of the users. The computer system 400 may use the communication channels to dynamically configure respective service applications of individual users. In particular, the computer system 400 may use memory resources 420 to store executable instructions (shown as “application configuration instructions 442”) that can be executed on the computer system 400 to configure the respective service applications that are operated on the mobile devices of users. As an addition or variation, the computer system 400 may transfer application configuration instructions 442 for execution or implementation by mobile devices of individual users. The computer system 400 may also enable individual mobile devices to receive and/or execute the service applications using a corresponding set of stored instructions (“service application instructions 438”). In this way, the computer system 400 can, for example, implement or enable the application configuration system 100, as described with an example of FIG. 1A and FIG. 1B.

Examples described herein are related to the use of the computer system 400 for implementing the techniques described herein. According to an aspect, techniques are performed by the computer system 400 in response to the processor 410 executing one or more sequences of one or more instructions contained in the memory resources 420. Such instructions may be read into the memory resources 420 from another machine-readable medium, such as the storage device 440. Execution of the sequences of instructions contained in the memory resources 420 may cause the processor 410 to perform the process steps described herein. In alternative implementations, hard-wired circuitry may be used in place of or in combination with software instructions to implement examples described herein. Thus, the examples described are not limited to any specific combination of hardware circuitry and software.

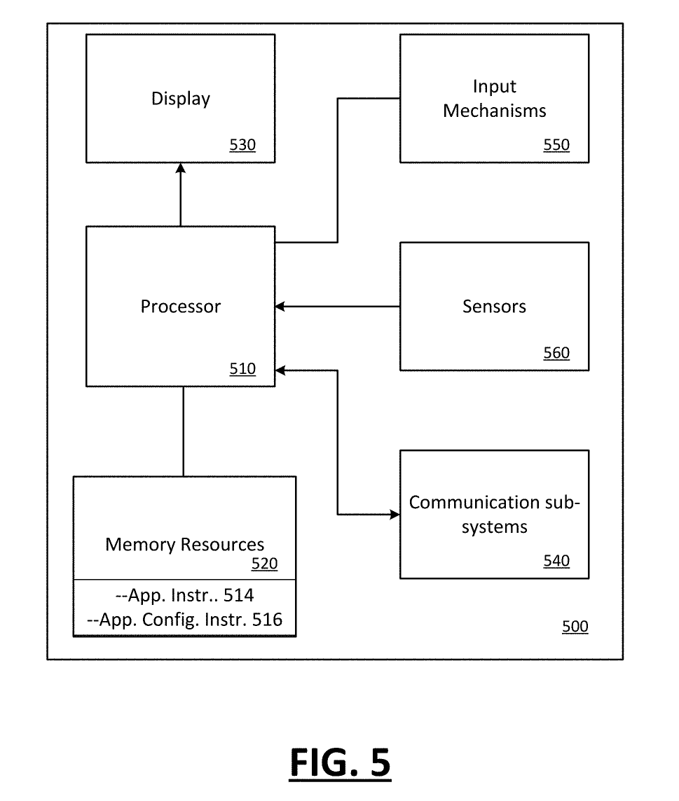

FIG. 5 is a block diagram that illustrates a mobile device upon which examples described herein may be implemented. In an example, a mobile device 500 may include a roaming device, capable of wireless communications (e.g., cellular device that is capable of telephony, messaging, and data services). Examples of such devices include smartphones, tablets (and phablets), and other portable or mobile devices capable of cellular or wireless fidelity (“WiFi”) communications.

With reference to an example of FIG. 5, a mobile device 500 includes a processor 510, memory resources 520, a display device 530 (e.g., such as a touch-sensitive display device), one or more communication sub-systems 540 (including wireless communication sub-systems), input mechanisms 550 (e.g., an input mechanism can include or be part of the touch-sensitive display device), and one or more sensors (e.g., a GPS component, an accelerometer, one or more cameras, etc.) 560. In one example, at least one of the communication sub-systems 540 sends and receives cellular data over data channels and voice channels.

The processor 510 can provide a variety of content to the display 530 by executing instructions and/or applications that are stored in the memory resources 520. For example, the processor 510 is configured with software and/or other logic to perform one or more processes, steps, and other functions, including to execute (i) application instructions 514 to implement, for example, application 140 of FIG. 1A, and (ii) application configuration instructions 516, to configure an appearance or functionality of an application feature or interface, as described with examples of FIG. 1A and FIG. 1B, as well as examples of FIG. 3A through FIG. 3C. Additionally, application instructions 516 may be used to implement a method such as described with an example of FIG. 2.

Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A computer system comprising:
a set of memory resources to store a set of instructions;
one or more processors to access the set of instructions;
wherein the instructions, when executed by the one or more processors, cause the computer system to perform operations that include:
accessing at least a first data source of a user to identify an indicator of an upcoming event;
determining a category and a set of service-related parameters for the event;
generating a workflow that is specific to at least one of the category or the set of service-related parameters, to determine a set of configuration parameters;
implementing a service request interface to include a feature from which the user can generate a service request for the event, wherein an aspect of the feature is based at least in part on the set of configuration parameters; and
associating the set of service-related parameters with the feature, so that when the service request is generated, the generated service request dynamically incorporates information corresponding to the set of service-related parameters.

2. The computer system of claim 1, wherein generating the workflow includes determining a third-party that is relevant to the event, and wherein configuring the service request includes providing the feature with a configuration parameter that identifies content that is indicative of the third-party.

3. The computer system of claim 2, wherein generating the workflow includes determining, based at least in part on that category or the set of service-related parameters, a vendor that is to perform a service related to the event.

4. The computer system of claim 3, wherein the vendor corresponds to one of an airline or a lodging.

5. The computer system of claim 3, wherein generating the workflow includes determining a branding content of the vendor, and wherein configuring the service request includes providing the feature to display the branding content.

6. The computer system of claim 2, wherein generating the workflow includes determining, based at least in part on the category or the set of service-related parameters, an identifier for at least one of a person, a social event, or a location, and wherein configuring the service request interface includes providing the feature with content that is specific to the person, the social event or the location.

7. The computer system of claim 6, wherein generating the workflow includes determining the content that is specific to the person, the social event, or the location using a data source of the user.

8. The computer system of claim 6, wherein the content that is specific to the person, the social event, or the location includes an image associated with the identifier of the person, the social event, or the location.

9. The computer system of claim 1, wherein generating the workflow includes determining a second set of service-related parameters for the event.

10. The computer system of claim 1, wherein accessing at least the first data source of the user to identify the indicator includes identifying one or more of a calendar source, contact source, message folder, or social network account.

11. The computer system of claim 1, wherein determining the event-specific information includes making a heuristic determination about the category of the event.

12. The computer system of claim 1, wherein the set of configuration parameters include a parameter corresponding to one of a text content or image content, which is repeatedly updated before a time interval associated with the feature.

13. The computer system of claim 12, wherein the set of configuration parameters include a service-related parameter.

14. The computer system of claim 1, wherein the set of configuration parameters provide that the aspect of an appearance of the application feature is dynamic over time.

15. A method for operating an application on a computer system, the method being implemented by one or more processors and comprising:
accessing at least a first data source of a user to identify an indicator of an upcoming event;
determining a category of the event and a set of service-related parameters for the event;
generating a workflow that is specific to at least one of the category or set of service-related parameters, to determine a set of configuration parameters;
providing an interface for the application, from which the user can generate a service request for the event, wherein an aspect of the interface is based at least in part on the set of configuration parameters; and
associating the set of service-related parameters with the interface, so that when the service request is generated, the generated service request dynamically incorporates information corresponding to the set of service-related parameters.

16. The method of claim 15, wherein generating the workflow includes determining a third-party that is relevant to the event, and wherein providing the interface includes providing the feature with a configuration parameter that identifies content that is indicative of the third-party.

17. The method of claim 15, wherein determining the event-specific information includes making a heuristic determination about the category of the event.

18. The method of claim 15, wherein the set of configuration parameters include a parameter corresponding to one of a text content or image content which is repeatedly updated before a time interval associated with the feature.

19. The method of claim 15, wherein the set of configuration parameters provide that the aspect of an appearance of the application feature is dynamic over time.

20. A non-transitory computer-readable medium that stores a set of instructions, which when executed by one or more processors, cause a computer system of the one or more processors to perform operations that include:
accessing at least a first data source of a user to identify an indicator of an upcoming event;
determining a category of the event and a set of service-related parameters for the event;
generating a workflow that is specific to at least one of the category or set of service-related parameters, to determine a set of configuration parameters;
providing an interface for the application, from which the user can generate a service request for the event, wherein an aspect of the interface is based at least in part on the set of configuration parameters; and
associating the set of service-related parameters with the interface, so that when the service request is generated, the generated service request dynamically incorporates information corresponding to the set of service-related parameters.
